(19) United States
(12) Patent Application Publication
(10) Pub. No.: US 2022/0105769 A1
(43) Pub. Date: Apr. 7, 2022

(54) METHOD AND APPARATUS FOR THE DYNAMIC CONTROL OF THE SUSPENSION SYSTEM OF A VEHICLE

(71) Applicant: ClearMotion, Inc., Billerica, MA (US)

(72) Inventors: Aditya Chandrashekhar Chetty, Fremont, CA (US); Allen Chung-Hao Chen, San Jose, CA (US)

(73) Assignee: ClearMotion, Inc., Billerica, MA (US)

(21) Appl. No.: 17/422,334

(22) PCT Filed: Jan. 16, 2020
(86) PCT No.: PCT/US20/13948

§ 371 Date: Jul. 12, 2021

Related U.S. Application Data
(60) Provisional application No. 62/793,092, filed on Jan. 16, 2019.

(51) Int. Cl. B60G 17/018; B60G 17/016

(52) U.S. Cl. CPC B60G 17/018; B60G 17/0162; B60G 2400/0523; B60G 2400/204; B60G 2800/0122; B60G 2400/41; B60G 2600/09; B60G 2600/172; B60G 2600/182; B60G 2400/252

(57) ABSTRACT

Methods and apparatus are disclosed for adjusting the front to rear ratio of roll damping and/or roll stiffness in a vehicle based on vehicle yaw rate and/or the rate of change of steering wheel angle. Also disclosed are methods and apparatus for dynamically adjusting one or more suspension system control parameters based on one or more of steering wheel angle, rate of change of steering wheel angle and yaw rate.

### CROSS REFERENCE OF RELATED APPLICATIONS

This application claims the benefit of priority to U.S. Provisional Application Ser. No. 62/793,092, filed Jan. 16, 2019 the disclosure of which is incorporated herein by reference in its entirety.

### BACKGROUND

Suspension systems of vehicles generally face tradeoffs between occupant comfort, vehicle safety, and/or vehicle handling. Controllable suspension systems (e.g., semi-active suspension systems and active suspension systems) may allow for some dynamic control of various characteristics of the suspension system.

### BRIEF DESCRIPTION OF THE DRAWINGS

FIG. 1 illustrates an embodiment of a vehicle having a suspension system.

FIG. 2 illustrates an embodiment of a controller for controlling a controllable element of a controllable suspension system.

FIG. 3 illustrates an embodiment of a controller for controlling a controllable element of a controllable suspension system.

FIG. 4 illustrates an embodiment of a controller for controlling a controllable element of a controllable suspension system.

FIG. 5 illustrates a flow chart of a method for controlling a controllable element of a controllable suspension system.

### SUMMARY

Various systems and methods are disclosed herein for controlling a controllable element (e.g., an actuator, a semi-active damper, an active roll-bar) of a controllable suspension system (e.g., an active suspension system, a semi-active suspension system) of a vehicle (e.g., a road vehicle).

In one aspect, a method for controlling a controllable element (e.g., an active suspension actuator, a semi-active damper) of a controllable suspension system (e.g., an active suspension system, a semi-active suspension system) of a vehicle (e.g., a road vehicle), is disclosed that comprises: determining (e.g., by a controller), using a first control strategy (e.g., a skyhook-based control), a first command for the controllable component; determining, using a second control strategy (e.g., a groundhook based control), a second command for the controllable component; determining, based at least in part on a measured vehicle parameter (e.g., a steering wheel angle, a rate of change of a steering wheel angle), a first weight for the first command and a second weight for the second command; determining, based at least in part on a weighted aggregate (e.g., a weighted sum, a weighted average) of the first command and the second command, an output command; outputting the output command to the controllable element; and, in response to the controllable element receiving the output command, varying a characteristic (e.g., an output force, a length, a damping coefficient) of the controllable element. In certain embodiments, the first control strategy utilizes a control loop (e.g., a feedback loop) based on a first control parameter and the second control strategy utilizes a control loop (e.g., a feedback loop) based on a second control parameter that is different from the first control parameter.

In certain embodiments, the controllable element is an active suspension actuator, the controllable suspension system is an active suspension system, and varying a characteristic of the controllable element comprises producing an output force with the actuator of the active suspension system. In certain embodiments, producing the output force with the actuator comprises applying, with the actuator, the output force to a first portion of the vehicle (e.g., a wheel, a portion (e.g., a corner) of a body of the vehicle). In certain embodiments, the vehicle may include a vehicle body and the method may include: sensing, using one or more motion sensors (e.g., accelerometers, IMUs), vertical motion of a portion of the vehicle body, wherein the first command is determined based at least in part on the sensed vertical motion. In certain embodiments, the first weight and/or the second weight are further determined based at least in part on an operating speed of the vehicle.

In another aspect, a method for controlling a controllable element (e.g., an active suspension actuator, a semi-active damper) of a controllable suspension system (e.g., an active suspension system, a semi-active suspension system) of a vehicle is disclosed that includes: determining, based at least in part on a measured vehicle parameter (e.g., a steering wheel angle, a rate of change of a steering wheel angle), a first set of one or more first gain values and a second set of one or more second gain values; determining (e.g., by a controller), using a first control loop (e.g., a skyhook-based control loop; a P, PI, PD, or PID-based control loop), a first command for the controllable component, wherein the first control loop utilizes the first set of gain values; determining, using a second control strategy (e.g., a groundhook based control loop; a P, PI, PD, or PID based control loop), a second command for the controllable component, wherein the second control loop utilizes the second set of gain values; determining, based at least in part on the first command and the second command, an output command; outputting the output command to the controllable element; and, in response to the controllable element receiving the output command, varying a characteristic (e.g., an output force, a length, a damping coefficient) of the controllable element.

In certain embodiments, the controllable element is an actuator, the controllable suspension system is an active suspension system, and varying a characteristic of the controllable element comprises: producing an output force with the actuator of the active suspension system. In certain embodiments, producing the output force with the actuator comprises: applying, with the actuator, the output force to a first portion of the vehicle (e.g., wherein the first portion of the vehicle is one of: a wheel, a portion (e.g., a corner) of a body of the vehicle).

In certain embodiments, the vehicle includes a vehicle body, and the method includes: sensing, using one or more motion sensors (e.g., accelerometers, IMUs), vertical motion of a portion of the vehicle body, and wherein the first command is determined based at least in part on the sensed vertical motion. In certain embodiments, the first set of gain values and/or the second set of gain values are further determined based at least in part on an operating speed of the vehicle.

In yet another aspect, an active suspension system of a vehicle is disclosed that includes: one or more actuators configured to apply a force in response to receiving a command (e.g., wherein each actuator is disposed between a portion of a body of the vehicle and a wheel assembly of the vehicle); a controller in communication with the one or more actuators, wherein the controller is configured to: determine, using a first control strategy (e.g., a skyhook-based control), a first command for the one or more actuators; determine, using a second control strategy (e.g., a groundhook based control), a second command for the one or more actuators; determine, based at least in part on a measured vehicle parameter (e.g., a steering wheel angle, a rate of change of a steering wheel angle), a first weight for the first command and a second weight for the second command; determine, based at least in part on a weighted aggregate (e.g., a weighted sum, a weighted average) of the first command and the second command, an output command; and output the output command to the one or more actuators.

In certain embodiments, the active suspension system includes one or more motion sensors (e.g., accelerometers, IMUs) arranged to sense vertical motion of a portion of the vehicle body, and the first command is determined based at least in part on the sensed vertical motion. In certain embodiments, the controller is configured to determine the first weight and/or the second weight based at least in part on an operating speed of the vehicle.

In yet another aspect, a method for controlling a controllable suspension system (e.g., an active suspension system, a semi-active suspension system) of a vehicle having a front axle and a rear axle is disclosed that includes: determining a desired yaw rate of the vehicle; measuring an actual yaw rate of the vehicle; comparing the desired yaw rate and the measured yaw rate; upon determining that the desired yaw rate exceeds the measured yaw rate, adjusting the suspension system to increase an effective roll parameter (e.g., roll stiffness and/or roll damping) of the rear axle relative to an effective roll parameter (e.g., roll stiffness and/or roll damping) of the front axle. It is understood that, in some embodiments, where a vehicle does not have a front axle (or a rear axle) or vehicles has independent suspension systems at two or more corners, suspension system elements of the front wheels (or rear wheels) may still cooperate to produce an effective roll stiffness and/or an effective roll damping at the front (or rear) of the vehicle.

In certain embodiments, the method further includes: measuring a rate of change of a steering wheel angle, and measuring an operating speed of the vehicle; wherein the desired yaw rate of the vehicle is determined based at least in part on the measured rate of change of the steering wheel angle and the measured operating speed of the vehicle. In certain embodiments, determining the desired yaw rate comprises: accessing a model (e.g., a lookup table, a mathematical simulation) that defines desired yaw rate as a function of rate of change of the steering wheel angle and operating speed of the vehicle.

In yet another aspect, a method for controlling a controllable suspension system (e.g., an active suspension system, a semi-active suspension system) of a vehicle having a front axle and a rear axle is disclosed that includes: determining a desired yaw rate of the vehicle; measuring an actual yaw rate of the vehicle; comparing the desired yaw rate and the measured yaw rate; and upon determining that the measured yaw rate exceeds the desired yaw rate, adjusting the suspension system to increase an effective roll parameter (e.g., roll stiffness and/or roll damping) of the front axle relative to a roll parameter (e.g., roll stiffness and/or roll damping) of the rear axle. In certain embodiments, the method further includes measuring a rate of change of a steering wheel angle and measuring an operating speed of the vehicle, wherein the desired yaw rate of the vehicle is determined based at least in part on the measured rate of change of the steering wheel angle and the measured operating speed of the vehicle. In certain embodiments, the desired yaw rate is determined by accessing a model (e.g., a lookup table, a mathematical simulation) that defines desired yaw rate as a function of rate of change of the steering wheel angle and operating speed of the vehicle.

In yet another aspect, a method of controlling an actuator of an active suspension system of a vehicle is disclosed that includes: based at least in part on a measured yaw rate of the vehicle, determining (e.g., by a controller) a command for the actuator; outputting the command to the actuator; and in response to the actuator receiving the command, producing a force with the actuator of the active suspension system. In certain embodiments, producing the force with the actuator comprises: applying, with the actuator, the force to a first portion of the vehicle (e.g., wherein the first portion of the vehicle is one of: a wheel, a portion (e.g., a corner) of a body of the vehicle).

In yet another aspect, a method for controlling a controllable suspension system (e.g., an active suspension system, a semi-active suspension system) of a vehicle having a vehicle front and a vehicle rear is disclosed. The rate of change of the steering angle may also be measured. When the vehicle is travelling above a certain threshold speed (the value of which may be predetermined), the ratio of roll damping at the vehicle front to roll damping at the vehicle rear and/or the ratio of roll stiffness at the front of the vehicle relative to roll stiffness at the rear of the vehicle may be adjusted based on the rate of change of the steering angle.

In yet another aspect, a method for controlling a controllable suspension system (e.g., an active suspension system, a semi-active suspension system) of a vehicle having a vehicle front and a vehicle rear is disclosed where the yaw rate of the vehicle is measured. Also, determined are a desired or expected yaw rate of the vehicle. Based on the difference between the measured yaw rate and the expected or desired yaw rate the ratio of roll damping at the vehicle front to roll damping at the vehicle rear, and/or the ratio of roll stiffness at the front of the vehicle relative to roll stiffness at the rear of the vehicle is adjusted.

In yet another aspect, a method for controlling a controllable suspension system (e.g., an active suspension system, a semi-active suspension system) of a vehicle having a vehicle front and a vehicle rear is disclosed. In one mode of operation, the method includes determining the rate of change of the steering wheel angle and the vehicle yaw rate and based on the values of one or both of these quantities, adjusting a value of a control parameter of a controller of the vehicle (e.g. a controller of the active or semi-active suspension system).

### DETAILED DESCRIPTION

A vehicle traveling along a road surface may undergo displacement and/or acceleration in the vertical direction due to changes in, for example, elevation, discontinuities, bumps or depressions in the road surface. In addition, vehicles may undergo fore-aft acceleration (e.g. due to braking and/or changes in speed) or lateral acceleration (e.g. due to turning). To mitigate the impact of road or inertially induced disturbances in order to improve passenger comfort, vehicle safety, and/or vehicle handling, a vehicle may utilize a suspension system that includes a series of dampers arranged to resist motion of the vehicle body with respect to the wheels of the vehicle. Conventional passive suspension systems face fundamental tradeoffs between comfort, safety and/o handling. In some embodiments, dynamically controllable suspension systems (e.g., semi-active suspension systems and active suspension systems) may be used that overcome some of the trade-offs between comfort, safety vs and handling associated with conventional passive suspension systems. Various aspects of exemplary active suspension systems and components thereof are described in U.S. Pat. No. 10,040,330, the contents of which are incorporated by reference herein in their entirety. In an exemplary active suspension system, one or more actuators (e.g. one actuator associated with each corner of a vehicle) may be arranged to actively apply a force to a portion of the vehicle (e.g., a corner of the vehicle body and/or a wheel of the vehicle) in response to a command. Alternatively, in an exemplary semi-active suspension system, semi-active dampers that are capable of varying their damping characteristics in response to a command may be utilized in place of passive dampers. Alternatively or additionally, a controllable suspension system may include an active anti-roll bar which may vary a roll stiffness of the vehicle in response to a controller.

In controllable suspension systems, various control strategies may be utilized to dynamically command the controllable component (e.g., an actuator of an active suspension system, a semi-active damper of a semi-active suspension system, or an active anti-roll bar). For example, a “skyhook” control strategy may be implemented to minimize absolute vertical movement of the vehicle body, regardless of road conditions or features, resulting in a ‘smooth’ ride to increase occupant comfort even when traveling over rough surfaces). Skyhook-based control may be used when occupant comfort is desired at some expense to handling performance and/or a natural road feel. Alternatively, other control strategies (e.g., a “groundhook” control strategy) may be implemented to optimize tire contact with the ground, leading to better handling performance but at some expense to occupant comfort. Traditionally in vehicles with controllable suspension systems, a user (e.g., a driver or a passenger of the vehicle) may have the ability to toggle between various control strategies—for example, a user could select between a “comfort” mode, which may rely primarily on a skyhook or other comfort-focused control strategy, and a “sport” mode, which may rely more heavily on a groundhook or other handling-focused control strategy.

In one aspect, the inventor has recognized that, in certain situations, it may be desirable to automatically vary a relative weight given to various control strategies, or modes, in response to certain vehicular parameters. For example, suppose a user is operating a vehicle with a controllable suspension system in a “comfort” mode, and the user suddenly and sharply turns the steering wheel while the vehicle is traveling at a high rate of speed. In some embodiments, it may be assumed that the sharp turn of the steering wheel may be in response to an emergency condition, such as trying to avoid an obstacle in the vehicle's path. In such a scenario, vehicle handling and/or safety may be considered more essential than occupant comfort, and so the controllable suspension system may dynamically switch to a “sport” mode, or a more handling-focused control strategy. Once normal steering is resumed, it may be assumed that the emergency situation is resolved, and the controllable suspension system may then switch back to a “comfort” mode. Alternatively, as discussed in detail herein, rather than “switching” between two discrete modes, the controllable suspension system may achieve a similar result either by dynamically assigning weights to commands determined by each control strategy and determining a weighted aggregate (e.g., a weighted sum or weighted average), or by using dynamic gain scheduling within a control loop associated with each control strategy.

Similarly, the inventor has recognized that a controllable suspension system may be utilized to affect steering dynamics of a vehicle, especially, for example, during high steering rate turns. Sharp turning maneuvers may result in reduced traction of either the front tires of the vehicle or rear tires of the vehicle, thereby resulting in a yaw rate that is either less than the desired yaw rate or that exceeds that desired yaw rate, respectively. For example, if the front tires lose some traction, or begin to “slip”, before the rear tires, a resulting yaw rate of the vehicle may be less than desired; if on the other hand the rear tires lose traction before the front tires, the resulting yaw rate of the vehicle may exceed a desired yaw rate. In either case, the vehicle may not follow the desired turning path and/or may result in an undesirable feeling of non-responsiveness or over responsiveness to the driver. The inventor has recognized that a controllable suspension system may be used to adjust the distribution of forces between the front tires and rear tires, thereby affecting the relative level of traction between the front tires and rear tires. As an example, if yaw rate is less than a desired or expected yaw rate—indicating that the front tires are slipping relative to the rear tires—the controllable suspension system may distribute forces such that the traction on the front tires is increased relative to the rear tires. This may be accomplished, in one exemplary embodiment, by increasing a roll parameter (e.g., a roll stiffness and/or roll damping) associated with the rear axle (or rear tires) of the vehicle relative a roll parameter associated with the front axle (or front tires) of the vehicle. Alternatively, if excessive yaw rate is observed, the controllable suspension system may distribute forces such that the relative traction on the rear tires is increased, e.g. by increasing a roll parameter associated with the front axle of the vehicle relative to a roll parameter associated with the rear axle of the vehicle.

Turning now to the figures, several non-limiting embodiments of various vehicles, suspension systems, suspension system components, and methods for controlling such components and systems are now described in detail. It should be understood that the various systems, components, features, and methods described relative to these embodiments may be used either individually and/or in any appropriate combination as the disclosure is not limited to only the specific embodiments described herein.

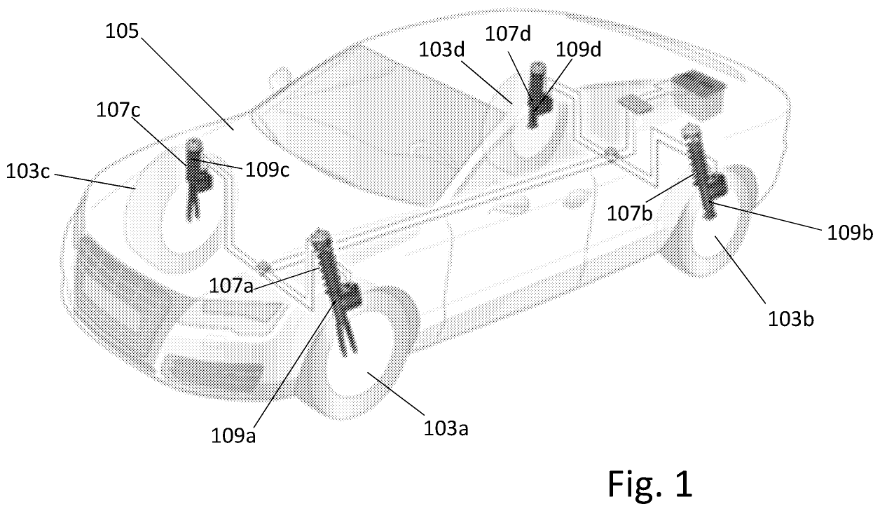

FIG. 1 illustrates an exemplary vehicle having four wheels 103a-d, with each wheel associated with a respective corner of the vehicle (e.g., front left 103a, rear left 103b, front right 103c, and rear right 103d). Each wheel may also include a tire that contacts the road surface. The vehicle also includes a vehicle body 105. The vehicle body 105 may be coupled to the wheels 103a-d of the vehicle via a suspension system that includes a spring 107a-d (e.g., a coil spring, an air spring) and a force generating device 109a-d interposed between each wheel of the vehicle and a corresponding corner of the vehicle body. In the illustrated embodiment, each spring is shown in a concentric arrangement with respect to its corresponding force generating device. However, it is understood that any appropriate arrangement may be utilized. The weight of the vehicle body may result in a normal force being exerted on each of the four wheels. When the vehicle is stationary, the relative magnitudes of each normal force at each corresponding wheel may be determined by the static weight distribution of the vehicle. When the vehicle is experiencing various maneuvers, e.g. braking, acceleration, or steering, vehicle dynamics may result in both vertical (i.e. out-of-plane) motion of the vehicle body (e.g., pitch, roll, heave) and in corresponding variations in the distribution of normal loads one or more wheels. For example, when rapid turning of the vehicle occurs, the outer front and outer rear corners of the vehicle body may drop (thereby compressing the corresponding suspension springs), while the inner front and inner rear corners of the vehicle may lift (thereby extending the corresponding suspension springs). In this case, the normal force exerted on the outer two wheels may increase (that is, the outer wheels may be ‘loaded’) while the normal force exerted on the inner two wheels may decrease (that is, the inner wheels may be ‘unloaded’).

In an active suspension system, each force generating device 109a-d may be an actuator. Various types of actuators as known in the art may be utilized, including without limitation hydraulic actuators, electromagnetic actuators, mechanical actuators (e.g. ball-screw), and/or electro-hydraulic actuators may be used. In a first mode of operation, the actuator may be configured to resist vertical motion of the vehicle body that occurs during braking, accelerating, or steering maneuvers (that is, it may function similar to a damper of a passive or semiactive suspension system). Additionally, in a second mode of operation, the actuator may be actively extended or compressed independently of dynamic forces imposed on the vehicle body. In a semi-active suspension system, the force generating device may be a semi-active damper, that is configured to resist vertical motion of the vehicle body, e.g. by providing a resisting or damping force

The controllable components of a controllable suspension system (e.g., the actuators of an active suspension system, the semi-active dampers of a semi-active suspension system, an active roll bar) may be capable of dynamically varying one or more properties in response to a command from a controller. For example, in certain embodiments, a force output by an actuator in an active suspension system may be varied in response to a command from a controller. Relatedly, the length of the actuator may be varied in response to a command from a controller. In a semi-active suspension system, damping characteristics (e.g., a damping coefficient) of the semi-active damper may be varied in response to a command from a controller. In some embodiments with an active roll bar, the roll stiffness may also be varied in response to a command from a controller.

In some embodiments, the controller may determine an appropriate command using a control strategy. A control strategy may rely on one or more control loops. In some embodiments of a feedback control loop, a desired set-point for a control parameter may first be identified, and one or more sensors may then be used to measure the value or state of the control parameter. Any difference between the measured value at a given time and the desired set-point is referred to as an error. In some embodiments, the controller may then determine a command based on the error. For example, the command may be determined by multiplying the error times a first gain (referred to in the art as “proportional control”, or P). In addition, the controller may also determine the command based on the integral of the error over a period of time (e.g., by multiplying the integral of the error times a second gain)(referred to in the art as “integral control”, or I) and/or based on the derivative of the error with respect to time (e.g., by multiplying the derivative of the error times a third gain)(referred to in the art as “derivative control”, or D). These types of control loops may be referred to as P, PI, PD, or PID control loops depending on which error functions are used to determine the command. However, other types of controllers may be used as the disclosure is not so limited.

For controllable suspension systems, the specific parameter chosen to serve as the control parameter, and/or the desired set-point of the control parameter, may depend on the overall goals or purpose of the suspension system. For example, if the primary goal or purpose of the system is occupant comfort, then it may be preferable to design the system to minimize vertical motion of the vehicle body. As discussed earlier, a skyhook control strategy may serve this purpose, by “smoothing” the ride as experienced by the occupant even when the vehicle traverses uneven surface. In some embodiments, a skyhook controller may use vertical velocity of the vehicle body as the control parameter, with a desired set-point of zero. In this embodiment, any measured vertical velocity of the vehicle body may be considered to be an undesirable error, and the controller may respond by determining a command to counter-act the measured vertical velocity. Vertical velocity of the vehicle body may be measured using one or more motion sensors (e.g., accelerometers, IMUs). As discussed earlier, while such a skyhook-based control strategy may improve comfort, it may also come at some expense to vehicle handling or road-holding capability. A handling-focused control strategy (e.g., a groundhook-based control strategy) may utilize alternative control parameters such as, for example, suspension velocity, tire slip, tire loading, etc.

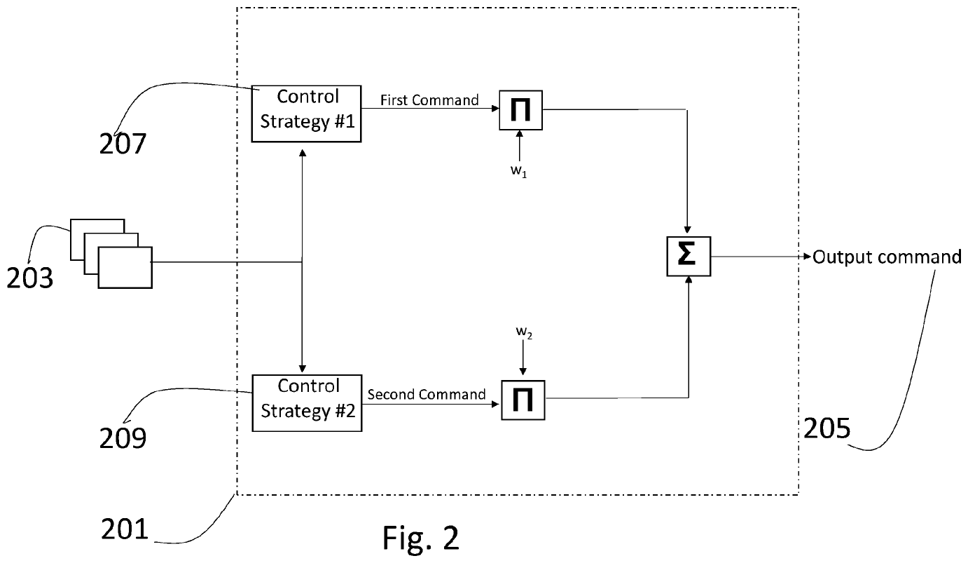

FIG. 2 illustrates an exemplary controller 201 of a controllable suspension system. In certain embodiments, the controller receives input from a set of one or more sensors 203. In various embodiments, the set of one or more sensors 203 may include one or more accelerometers (e.g., one accelerometer associated with each wheel of the vehicle), one or more IMUs, one or more sensors associated with a tire of the vehicle (e.g., a tire pressure sensor, tire rotational speed sensor, etc.), or one or more suspension position sensors. In certain embodiments, the controller may be configured to determine an output command 205 based at least in part on the input from the set of one or more sensors 203. In certain embodiments, the controller may be configured to execute a plurality of control strategies, including a first control strategy 207 and a second control strategy 209. For example, the first control strategy 207 may be comfort-focused (e.g., a skyhook-based control) while the second control strategy 209 may be handling-focused (e.g., a groundhook-based control). In certain embodiments, the controller may be configured to determine a first command, based at least in part on the input from the set of one or more sensors, using the first control strategy 207 and configured to determine a second command, based at least in part on the input from the set of sensors, using the second control strategy 209. The controller may then determine the output command 205 as a function (e.g., a weighted sum or a weighted average) of the first command and second command. The output command 205 may be communicated from the controller to the controllable component of the suspension system (e.g., the actuator, the semi-active damper). In response to receiving the output command, the controllable component may vary one or more of its characteristics.

It is understood that the first control strategy and second control strategy may rely on different input parameters in determining the first command and second command, respectively. For example, the first control strategy may determine the first command based on vertical velocity of the body while the second control strategy may determine the second command based on suspension velocity. As used herein, suspension velocity associated with a corner of a vehicle refers to a rate of change of a vertical distance (e.g. shortest vertical distance) between a wheel and the corner of the vehicle body associated with that wheel.

In certain embodiments, respective weights assigned to the first command and the second command may be based on user selection. For example, the vehicle may include a user interface that allows a user (e.g., a driver or an occupant of the vehicle) to indicate a desired vehicle mode. For example, the user may select a “comfort” mode if they desire a more comfortable ride, or the user may select a “sport” mode if they desire a sportier ride. Depending on the user selection, a first weight (denoted w₁) may be assigned to the first command and a second weight (denoted w₂) may be assigned to the second command. For example, in the comfort mode, the relative weight assigned to the first command may be higher than that assigned to the second command; while in the sport mode, the relative weight assigned to the second command may be higher than that assigned to the first command. If a weight of zero is used for either the first or second command, then that command is effectively discarded and only one of the control strategies is utilized to determine the output command.

The inventor has recognized that it, in some situations, it may be desirable to favor one control strategy over another regardless of user selection. For example, in some embodiments, while a vehicle is operating in “comfort” mode, and the steering wheel may be turned rapidly while the vehicle is traveling at a high rate of speed. In some embodiments, such a sequence of events may be assumed to indicate a sharp turn of the steering wheel in response to an emergency condition, such as trying to avoid an obstacle in the vehicle's path. In such a scenario, vehicle handling may be considered more essential than occupant comfort. Accordingly, in some embodiments, one or more sensors may be used to determine that the steering wheel has been turned at a rate that is faster than a predetermined threshold value when the vehicle is travelling faster than a predetermined speed. Under these conditions, the command determined from the control strategy associated with better handling may be weighted more heavily relative to the other control strategy (e.g., that may be associated with more comfort). Likewise, in certain embodiments, a vehicle may include a collision avoidance system that is capable of sensing obstacles in the path of the vehicle and commanding a steering maneuver to avoid the obstacle. In certain embodiments, when the collision avoidance system detects that an object is present within the path of the vehicle and commands a steering maneuver, the control strategy associated with better handling may be weighted more heavily relative to the other control strategy (e.g., that may be associated with more comfort).

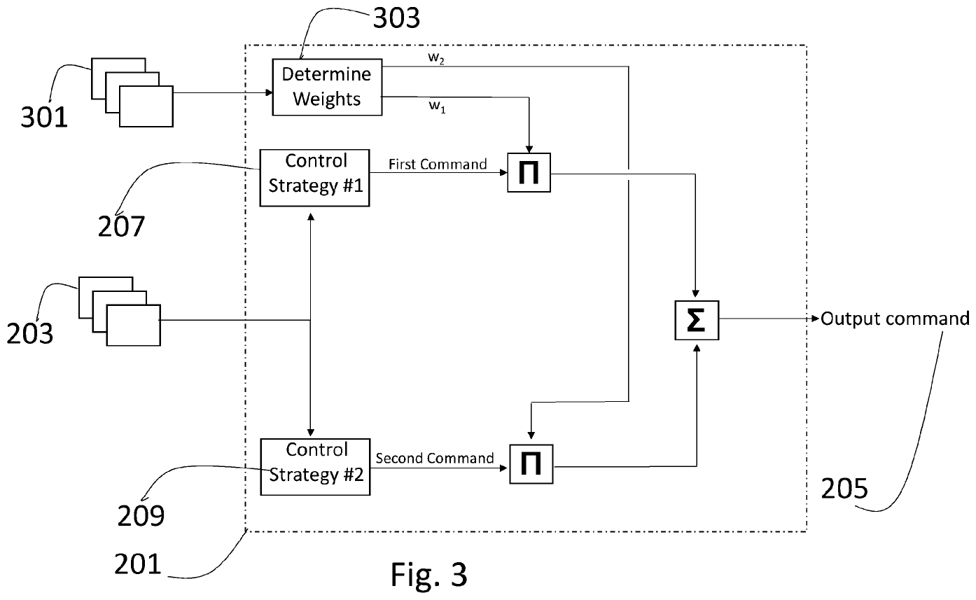

FIG. 3 illustrates another embodiment of a controller. The exemplary controller of FIG. 3 is similar to that of FIG. 2, but with the addition of a weighting algorithm 303. In the illustrated example, the controller receives a second input from a second set of one or more sensors 301. In certain embodiments, the second set of one or more sensors 301 includes a steering wheel angle sensor. In certain embodiments, the controller determines the first weight and the second weight based at least in part on the second input (e.g., the steering wheel angle). In certain embodiments, the weights may be proportional to the steering wheel angle and/or the rate of change thereof, such that an increase in steering wheel angle and/or rate of change thereof results in a higher relative weighting of the second control strategy. In certain embodiments, the controller may compare the steering wheel angle and/or a rate of change thereof with a threshold value. If the steering wheel angle, and/or the rate of change thereof, exceeds a threshold value, then it may be assumed, for example, that the requested steering maneuver corresponds to an emergency maneuver (e.g., the user is trying to avoid collision with an obstacle in the path of the vehicle). Therefore, when the steering wheel angle and/or rate of change thereof exceeds the threshold value, in certain embodiments the relative weights assigned to the first command and second command may be determined such that the control strategy associated with handling is given a larger relative weight. In certain embodiments, the first weight or second weight may be assigned a value of zero, such that either the first command or second command is effectively discarded.

The inventor has further recognized that, in addition to a steering wheel angle and/or rate of change thereof, it may be advantageous to determine relative weights based at least in part on an operating speed of the vehicle. At low operating speeds, such as, for example, those typical of parking lots, sharp turns may be part of normal driving and may not require enhanced handling measures. Therefore, in certain embodiments, the second set of one or more sensors may include a vehicle speed sensor. In certain embodiments, the threshold value for steering angle or rate of change thereof may be determined based at least in part on the measured vehicle speed.

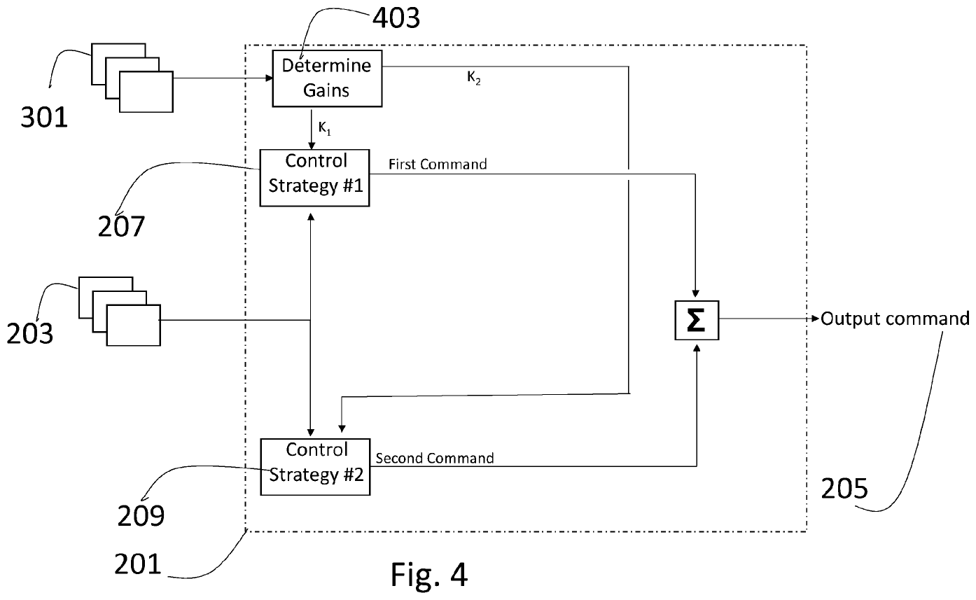

The exemplary embodiments of FIG. 2 and FIG. 3 use a weighted function of the first command and the second command to determine the output command. Alternatively, a similar functional result may be reached by using dynamic gain scheduling, as illustrated in FIG. 4, rather than or in addition to dynamic weighting. In certain embodiments, the first control strategy and the second control strategy may utilize control loops that include one or more gain values. For example, in some embodiments, a PID control loop may have a first gain associated with the proportional term, a second gain associated with the integral term, and a third gain associated with the derivative term. A PI or PD controller, likewise, may have a first gain for the proportional term and a second gain for the integral or derivative term. In certain embodiments, the one or more gains associated with each control strategy may be dynamically determined based at least in part on the input from the second set of sensors 301. In certain embodiments, therefore, the controller may be configured to dynamically assign, based at least in part on the input from the second set of sensors 301, one or more first gains associated with the first control strategy and/or one or more second gains associated with the second control strategy. As would be recognized by one of ordinary skill, gain scheduling can be used to accomplish effectively equivalent results as weighting. For example, relatively increasing one or more first gains (denoted K₁) associated with the first control strategy has the effect of weighting the first command relative to the second command. In certain embodiments, a combination of gain scheduling and weighting may be utilized.

Turning maneuvers may result in roll of the vehicle body, the degree of which may depend on the vehicle's lateral acceleration and the rate of which (that is, the roll rate) may depend on the vehicle's lateral jerk. In general, when a vehicle maneuvers around a turn, the outside of the vehicle body drops relative to the inside of the vehicle body Likewise, loading on the outer tires of the vehicle increases relative to loading on the inner tires. A suspension system of the vehicle may resist and/or retard roll by applying a force that counter-acts roll. Particularly, roll stiffness refers to the extent to which the vehicle resists roll (e.g., by applying a counter-acting force that is proportional to roll angle), while roll damping refers to the extent to which the vehicle retards roll (e.g., by applying a counter-acting force that is proportional to roll rate). As used herein, the term “roll parameter” encompasses both roll stiffness and roll damping. Generally, each axle of a vehicle may have independent roll parameters. For example, in an exemplary vehicle having four wheels, the front two wheels are typically disposed along a front axle and the rear two wheels are typically disposed along a rear axle. The front axle may have different roll parameters (e.g., a different roll stiffness and/or a different roll damping) than the rear axle. In some embodiments where the vehicle has no front or rear axle, the suspension system components associated with the front wheels may have different roll parameters (e.g., a different effective roll stiffness and/or a different effective roll damping) than the system components associated with the rear wheels.

In controllable suspension systems, one or more roll parameters may be dynamically varied. For example, if roll is detected or predicted in a given vehicle having an active suspension system, the controllable suspension system may respond by commanding one or more actuators associated with the outer tires or outer corners of the vehicle to extend while commanding any actuators associated with the inner tires or inner corners of the vehicle to compress. The extent to which the actuators are commanded to respond to the detected or predicted roll and/or detected or predicted roll rate may determine the effective roll parameters of the vehicle. In certain embodiments, roll or roll rate of the vehicle body may be continuously monitored or predicted. For example, one or more motion sensors (e.g., accelerometers, IMU, gyroscopes) may be used to measure roll or roll rate. In certain embodiments, a vehicle may utilize a plurality of accelerometers, wherein one or more accelerometers are associated with a particular corner of the vehicle body and/or a wheel of the vehicle. The roll and/or roll rate of the vehicle body may then be determined by comparing the measured acceleration one or more accelerometers. In certain embodiments, the controller may determine the output command based at least in part on the observed or predicted roll and/or roll rate of the vehicle body. In some embodiments, the roll and/or roll rate may be predicted by using a dynamic model of the vehicle.

In some embodiments of a passenger vehicle having four wheels, the front two wheels may be located on a common front axle and the rear two wheels may be located on a common rear axle. The inventor has recognized that, in vehicles having a controllable suspension system, a roll parameter associated with the front axle and rear axles may be independently controlled. For example, as shown in FIG. 1, a controllable suspension system may include an active or passive force generating device 109a-d interposed between each wheel of the vehicle and a corresponding corner of the vehicle body. In response to observed or predicted roll of the vehicle body, a controller may in some operating modes, for example, command the force generating devices associated with the vehicle's front wheels to respond aggressively to counteract such roll (e.g., such that the front axle has a relatively high effective roll stiffness and/or roll damping), while commanding the force generating devices associated with the vehicle's rear wheels to resist roll as aggressively (e.g., such that the rear axle has a relatively low effective roll stiffness and/or low roll damping), or vice versa.

The inventor has recognized that the relative ratio of roll parameters between the front axles and the rear axles (e.g., the ratio of front axle roll stiffness to rear axle roll stiffness and/or the ratio of front axle roll damping to rear axle roll damping) may be used to influence steering dynamics, such as, for example, during turning maneuvers. Sharp turning maneuvers may result in loss of traction of either the front tires of the vehicle or rear tires of the vehicle, thereby resulting in a yaw rate that is either less than the desired or expected yaw rate or that exceeds that desired or expected yaw rate, respectively. Increasing the effective roll parameters (e.g. roll stiffness or roll damping) of the rear axle relative to the front axle may result in relatively increased load transfer at the rear tires and increased traction at the front tires, thereby counteracting an insufficient observed yaw rate. Likewise, increasing the effective roll parameters (e.g. roll stiffness or roll damping) of the of the front axle relative to the rear axle may result in relatively increased load transfer at the rear tires and increased traction and loading on the rear tires, thereby counteracting an excessive observed yaw rate.

In certain embodiments, a yaw rate of a vehicle may be continually monitored with one or more sensors by. Yaw rate may be measured using, for example, a gyroscope and/or an IMU positioned in the vehicle. In certain embodiments, a model (e.g., a lookup table, a mathematical simulation) may be utilized that describes desired yaw rate as a function of both steering wheel angle (or rate of change thereof) and speed. In some embodiments, based on a steering wheel angle sensor and the vehicle speed sensor, the controller may determine a desired yaw rate, and compare the desired yaw rate with the measured yaw rate. In some embodiments when measured yaw rate is less than the desired or expected yaw rate, then the front tires may not have sufficient traction. The controller may respond by commanding the controllable suspension system to increase a roll parameter of the rear axle or suspension elements associated with the rear tires relative to a roll parameter of the front axle or suspension elements associated with the front tires (e.g., to increase the roll stiffness of the rear axle relative to the roll stiffness of the front axle, and/or to increase the roll damping of the rear axle relative to the front axle). When measured yaw rate exceeds the desired or expected yaw rate, then the rear tires may not have sufficient traction. The controller may respond by commanding the controllable suspension system to increase a roll parameter of the front axle or suspension elements associated with the front tires relative to a roll parameter of the rear axle axle or suspension elements associated with the rear tires.

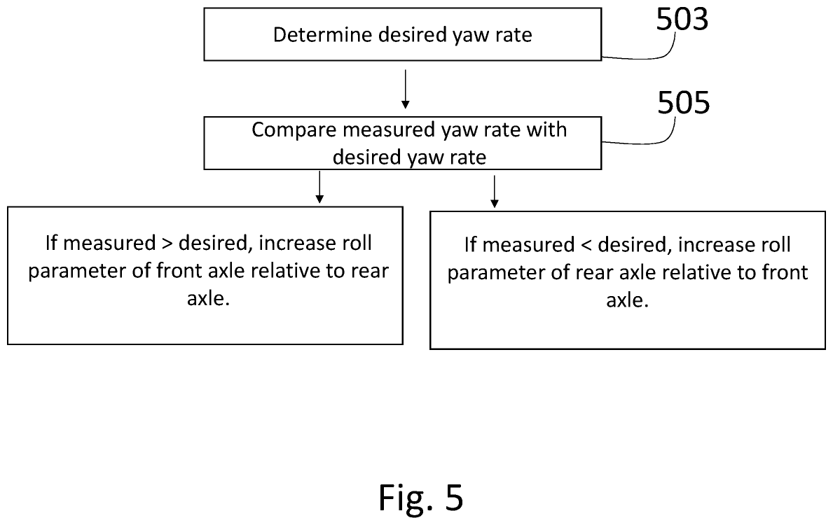

FIG. 5 illustrates an exemplary method of controlling a controllable suspension system based in part on an observed yaw rate. In a first step 503, a desired yaw rate is determined based at least in part on a measured steering wheel angle (or rate of change thereof) and an operating speed of the vehicle. The desired yaw rate may be vehicle specific, and may be defined, for example, by a model (e.g., a lookup table, mathematical simulation, or algorithm) that defines desired vehicle performance in response to steering commands at a given speed. In a second step 505, the measured yaw rate (e.g., measured by a gyroscope) may be compared to the desired yaw rate. If the measured yaw rate is less than the desired yaw rate, then the controller may respond by commanding the controllable suspension system to increase a roll parameter of the rear axle relative to the front axle. If the measured yaw rate exceeds the desired yaw rate, then the controller may respond by commanding the controllable suspension system to increase a roll parameter of the front axle relative to the rear axle.

The various embodiments described herein are not exclusive, and features of different embodiments may be combined in various combinations. For example, in certain embodiments, the output command determined by embodiments illustrated in FIGS. 2-4 may be scaled according to a desired ratio of roll parameters of each axle (e.g., as determined by the exemplary method of FIG. 5). Further, in various embodiments, as would be recognized by one of ordinary skill in the art, the functions ascribed to a single controller herein may be distributed among a plurality of controllers. A controller may include one or more microprocessors (e.g., a general purpose processes or an ASIC) and associated circuitry.

1. A method for controlling a controllable element of a controllable suspension system of a vehicle, the method comprising:
determining, using a first control strategy, a first command for the controllable component;
determining, using a second control strategy, a second command for the controllable component;
determining, based at least in part on a measured vehicle parameter, a first weight for the first command and a second weight for the second command;
determining, based at least in part on a weighted aggregate of the first command and the second command, an output command;
outputting the output command to the controllable element;
in response to the controllable element receiving the output command, varying a characteristic of the controllable element.

2. The method of claim 1, wherein the controllable element is an active suspension actuator, the controllable suspension system is an active suspension system, and wherein varying a characteristic of the controllable element comprises: producing an output force with the actuator of the active suspension system.

3. The method of claim 2, wherein producing the output force with the actuator comprises:
applying, with the actuator, the output force to a first portion of the vehicle.

4. The method of claim 1, wherein the vehicle includes a vehicle body, the method comprising:
sensing, using one or more motion sensors, vertical motion of a portion of the vehicle body, and wherein the first command is determined based at least in part on the sensed vertical motion.

5. The method of claim 1, wherein the first weight and/or the second weight are further determined based at least in part on an operating speed of the vehicle.

6. A method for controlling a controllable element of a controllable suspension system of a vehicle, the method comprising:
determining, based at least in part on a measured vehicle parameter, a first set of one or more first gain values and a second set of one or more second gain values;
determining, using a first control loop, a first command for the controllable component, wherein the first control loop utilizes the first set of gain values;
determining, using a second control loop, a second command for the controllable component, wherein the second control loop utilizes the second set of gain values;
determining, based at least in part on the first command and the second command, an output command;
outputting the output command to the controllable element;
in response to the controllable element receiving the output command, varying a characteristic of the controllable element.

7. The method of claim 6, wherein the controllable element is an actuator, the controllable suspension system is an active suspension system, and wherein varying a characteristic of the controllable element comprises: producing an output force with the actuator of the active suspension system.

8. The method of claim 7, wherein producing the output force with the actuator comprises:
applying, with the actuator, the output force to a first portion of the vehicle.

9. The method of claim 6, wherein the vehicle includes a vehicle body, the method comprising:
sensing, using one or more motion sensors, vertical motion of a portion of the vehicle body, and wherein the first command is determined based at least in part on the sensed vertical motion.

10. The method of claim 6, wherein the first set of gain values and/or the second set of gain values are further determined based at least in part on an operating speed of the vehicle.

11. An active suspension system of a vehicle, the active suspension system comprising:
one or more actuators configured to apply a force in response to receiving a command;
a controller in communication with the one or more actuators, wherein the controller is configured to:
determine, using a first control strategy, a first command for the one or more actuators;
determine, using a second control strategy, a second command for the one or more actuators;
determine, based at least in part on a measured vehicle parameter, a first weight for the first command and a second weight for the second command;
determine, based at least in part on a weighted aggregate of the first command and the second command, an output command; and
output the output command to the one or more actuators.

12. The active suspension system of claim 11 comprising one or more motion sensors arranged to sense vertical motion of a portion of the vehicle body, and wherein the first command is determined based at least in part on the sensed vertical motion.

13. The method of claim 11, wherein the controller is configured to determine the first weight and/or the second weight based at least in part on an operating speed of the vehicle.

14. A method for controlling a controllable suspension system of a vehicle having a front axle and a rear axle, the method comprising:
determining a desired yaw rate of the vehicle;
measuring an actual yaw rate of the vehicle;
comparing the desired yaw rate and the measured yaw rate;
upon determining that the desired yaw rate exceeds the measured yaw rate, adjusting the suspension system to increase an effective roll parameter of the rear axle relative to an effective roll parameter of the front axle.

15. The method of claim 14, further comprising:
measuring a rate of change of a steering wheel angle;
measuring an operating speed of the vehicle;
wherein the desired yaw rate of the vehicle is determined based at least in part on
the measured rate of change of the steering wheel angle and the measured operating speed of the vehicle.

16. The method of claim 15, wherein determining the desired yaw rate comprises:
accessing a model that defines desired yaw rate as a function of rate of change of the steering wheel angle and operating speed of the vehicle.

17. A method for controlling a controllable suspension system of a vehicle having a front axle and a rear axle, the method comprising:
determining a desired yaw rate of the vehicle;
measuring an actual yaw rate of the vehicle;
comparing the desired yaw rate and the measured yaw rate;
upon determining that the measured yaw rate exceeds the desired yaw rate, adjusting the suspension system to increase an effective roll parameter of the front axle relative to a roll parameter of the rear axle.

18. The method of claim 14, further comprising:
measuring a rate of change of a steering wheel angle;
measuring an operating speed of the vehicle;
wherein the desired yaw rate of the vehicle is determined based at least in part on
the measured rate of change of the steering wheel angle and the measured operating speed of the vehicle.

19. The method of claim 15, wherein determining the desired yaw rate comprises:
accessing a model that defines desired yaw rate as a function of rate of change of the steering wheel angle and operating speed of the vehicle.

20. A method of controlling an actuator of an active suspension system of a vehicle, the method comprising:
based at least in part on a measured yaw rate of the vehicle, determining a command for the actuator;
outputting the command to the actuator;
in response to the actuator receiving the command, producing a force with the actuator of the active suspension system.

21. The method of claim 20, wherein producing the force with the actuator comprises:
applying, with the actuator, the force to a first portion of the vehicle.

22. A method for controlling a controllable suspension system of a vehicle having a vehicle front and a vehicle rear and travelling at a speed, the method comprising:
determining that the speed is above a threshold value;
determining a rate of change of a steering wheel angle;
based on the rate of change of the steering wheel angle, adjusting at least one quantity selected from the group consisting of: ratio of roll damping at the vehicle front to roll damping at the vehicle rear, and ratio of roll stiffness at the front of the vehicle relative to roll stiffness at the rear of the vehicle.

23. A method for controlling a controllable suspension system of a vehicle having a vehicle front and a vehicle, the method comprising:
determining a measured yaw rate of the vehicle;
determining a desired yaw rate of the vehicle;
determining that the difference between the measured yaw rate and the desired yaw rate is greater than a threshold value;
based on the difference, adjusting at least one quantity selected from the group consisting of: ratio of roll damping at the vehicle front to roll damping at the vehicle rear, and ratio of roll stiffness at the front of the vehicle relative to roll stiffness at the rear of the vehicle.

24. A method for controlling a controllable suspension system of a vehicle having a vehicle front and a vehicle rear and travelling at a speed, the method comprising:
determining a quantity selected from the group consisting of a rate of change of a steering wheel angle a vehicle yaw rate;
based on quantity, adjusting a value of a control parameter of a controller of the vehicle.
